(19) United States
(12) Patent Application Publication
(10) Pub. No.: US 2013/0174730 A1
(43) Pub. Date: Jul. 11, 2013

(54) ENERGY RECOVERY VENTILATOR AND DEHUMIDIFIER

(71) Applicant: Kenneth W. Kayser, Salem, VA (US)

(72) Inventor: Kenneth W. Kayser, Salem, VA (US)

(21) Appl. No.: 13/744,634

(22) Filed: Jan. 18, 2013

Related U.S. Application Data
(63) Continuation of application No. 12/581,806, filed on Oct. 19, 2009, now abandoned.

(51) Int. Cl. B01D 53/26

(52) U.S. Cl. CPC B01D 53/261
USPC 95/10; 96/111

(57) ABSTRACT

An energy recovery ventilator system includes a belt partially located in each of a first chamber and a second chamber. First and second desiccant units are positioned on the belt. At least some of the first desiccant units are in the first chamber at a first relative humidity, causing air received in the first chamber to achieve a first air humidity. At least some of the second desiccant units are in the second chamber at a second relative humidity, the second relative humidity being caused by the air received in the first chamber. The second relative humidity is modified to the first relative humidity by air passing through the second chamber, the air achieving a second air humidity. A controller causes the belt to move second desiccant units from the second chamber to the first chamber when the first air humidity fails to comply with a specific air humidity.

### FIELD OF THE INVENTION

The present invention relates generally to an energy recovery system, and, more particularly, to an energy recovery ventilator and dehumidifier having a desiccant in a saturated equilibrium state.

### SUMMARY OF THE INVENTION

According to one aspect, an energy recovery ventilator system includes a first chamber and a second chamber. A moving belt has a first portion positioned in the first chamber and a second portion positioned in the second chamber. A plurality of desiccant units are positioned on the moving belt, the plurality of desiccant units including a plurality of first desiccant units and a plurality of second desiccant units, each of the desiccant units being in a saturated stated. The first desiccant units are located in the first chamber at a first relative humidity for causing air received in the first chamber to achieve a first air humidity. The second desiccant units are located in the second chamber at a second relative humidity, the second relative humidity being caused by the air received in the first chamber. The second desiccant units are modified back to the first relative humidity by air passing through the second chamber, the air passing through the second chamber achieving a second air humidity. A controller is communicatively coupled to the moving belt and is operable to cause movement of the moving belt. Specifically, the controller causes the moving belt to move at least some of the second desiccant units from the second chamber to the first chamber when the first air humidity fails to comply with a predetermined air humidity.

According to another aspect, a method for recovering energy in a ventilator system is directed to receiving fresh air from an external environment into a dehumidifier chamber. Moisture is adsorbed from the fresh air to a plurality of first desiccant units to lower the humidity of the fresh air, the first desiccant units being in a saturated state at a first relative humidity. Dehumidified air is sent into a room environment, and room air is received from the room environment into an energy recovery chamber. Moisture is removed from the room air to a plurality of second desiccant units, the second desiccant units being in a saturated state at a second relative humidity. The removal of the moisture causes the saturated state at the second relative humidity of the second desiccant units to change to the saturated state at the first relative humidity. In response to determining that relative humidity of fresh air is higher than a predetermined humidity, at least one of the first desiccant units from the dehumidifier chamber is replaced with a corresponding one of the second desiccant units from the energy recovery chamber.

### BRIEF DESCRIPTION OF THE DRAWINGS

The invention may best be understood by reference to the following description taken in conjunction with the accompanying drawings, in which:

FIG. 1 is a diagrammatic of an energy recovery ventilator system, according to one embodiment.

FIG. 2 is a chart illustrating adsorbent capacities of Silica Gel.

FIG. 3 is an illustration of the energy recovery ventilator system in an energy recovery ventilator (ERV) and regeneration mode.

FIG. 4 is an illustration of the energy recovery ventilator system in a dehumidifier mode.

FIG. 5 is an illustration showing sensors of the energy recovery ventilator system

FIG. 6 is a perspective view of a heat exchanger and duct system, according to an alternative embodiment.

FIG. 7 is a side view illustration of the heat exchanger.

FIG. 8 is a perspective exploded view of the heat exchanger.

FIG. 9 is a top view illustration of a partial layer of the heat exchanger having a plurality of air-diverting deformations, according to one embodiment.

FIG. 10 is a top view illustration of a partial layer of the heat exchanger having an array of air-diverting deformations, according to an alternative embodiment.

### DETAILED DESCRIPTION OF THE ILLUSTRATED EMBODIMENTS

Although the invention will be described in connection with certain preferred embodiments, it will be understood that the invention is not limited to those particular embodiments. On the contrary, the invention is intended to cover all alternatives, modifications, and equivalent arrangements as may be included within the spirit and scope of the invention as defined by the appended claims.

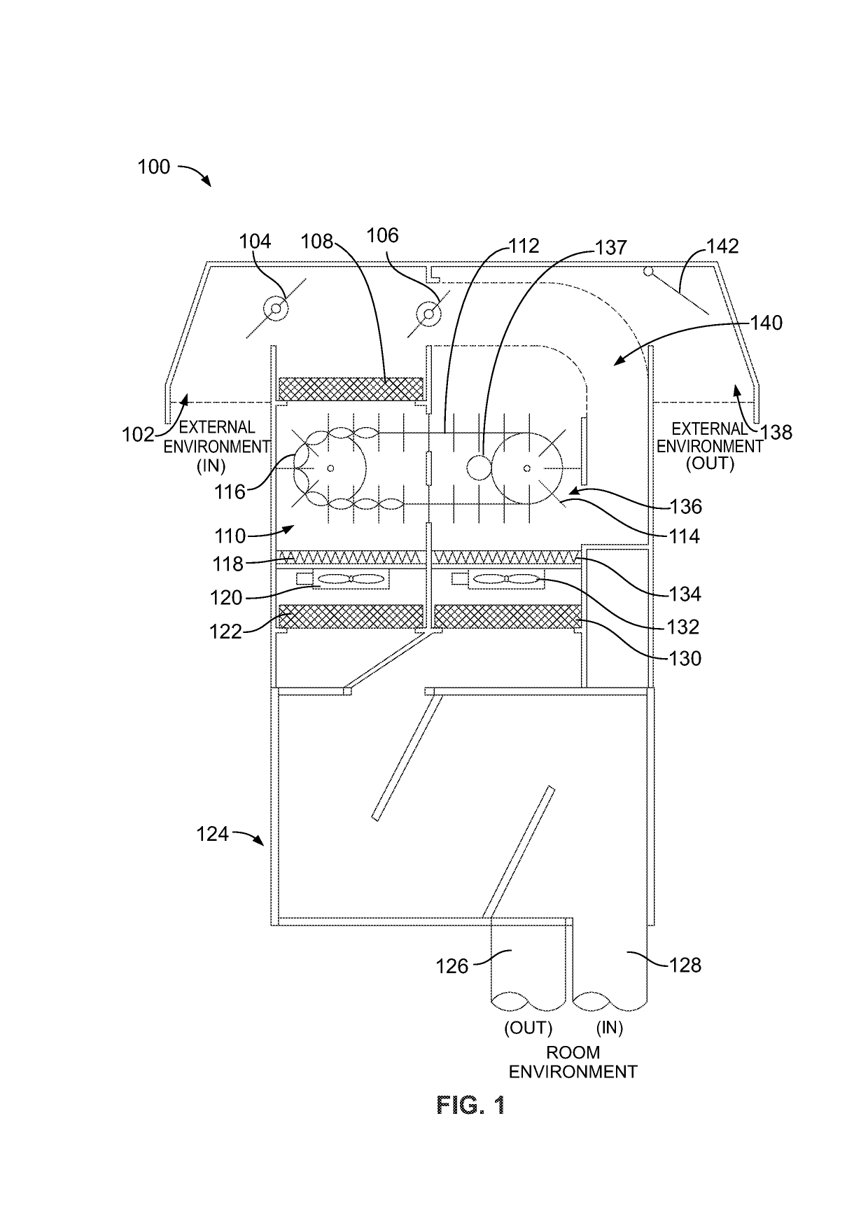

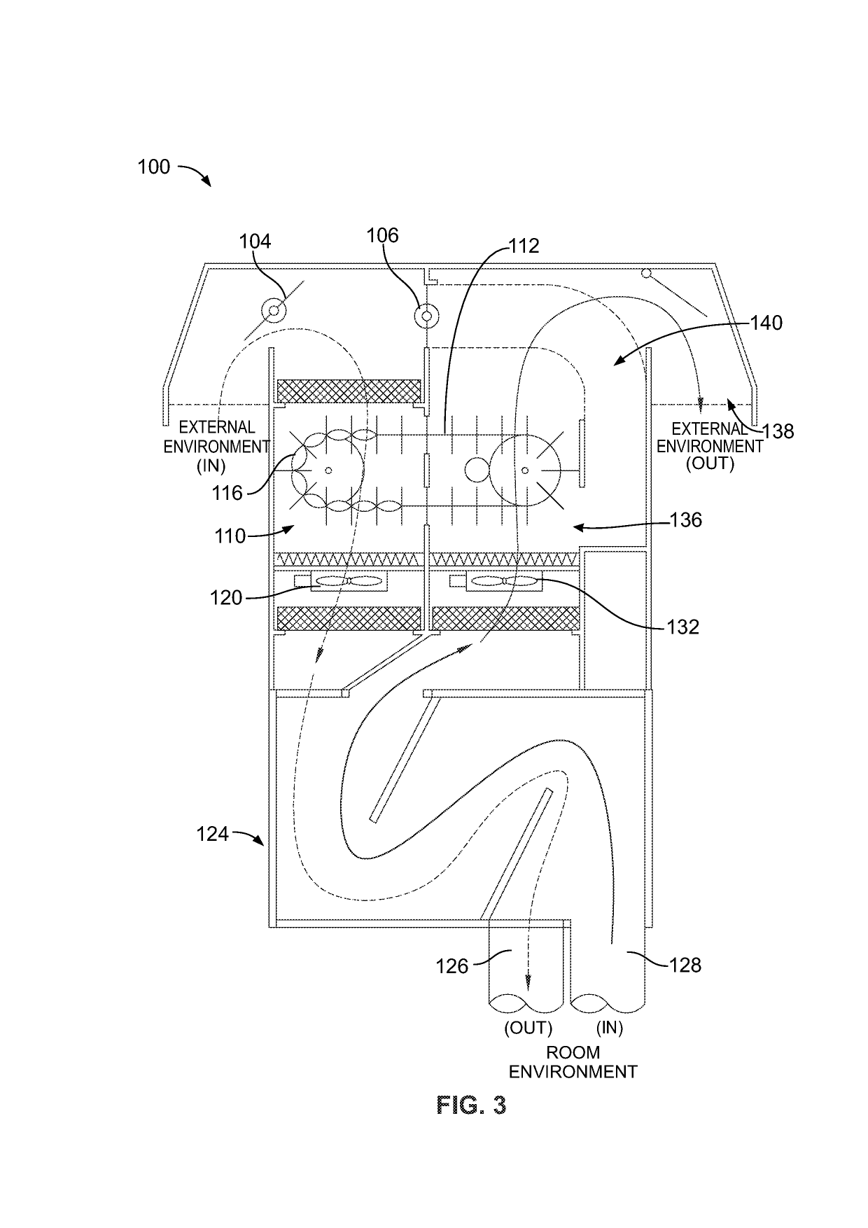

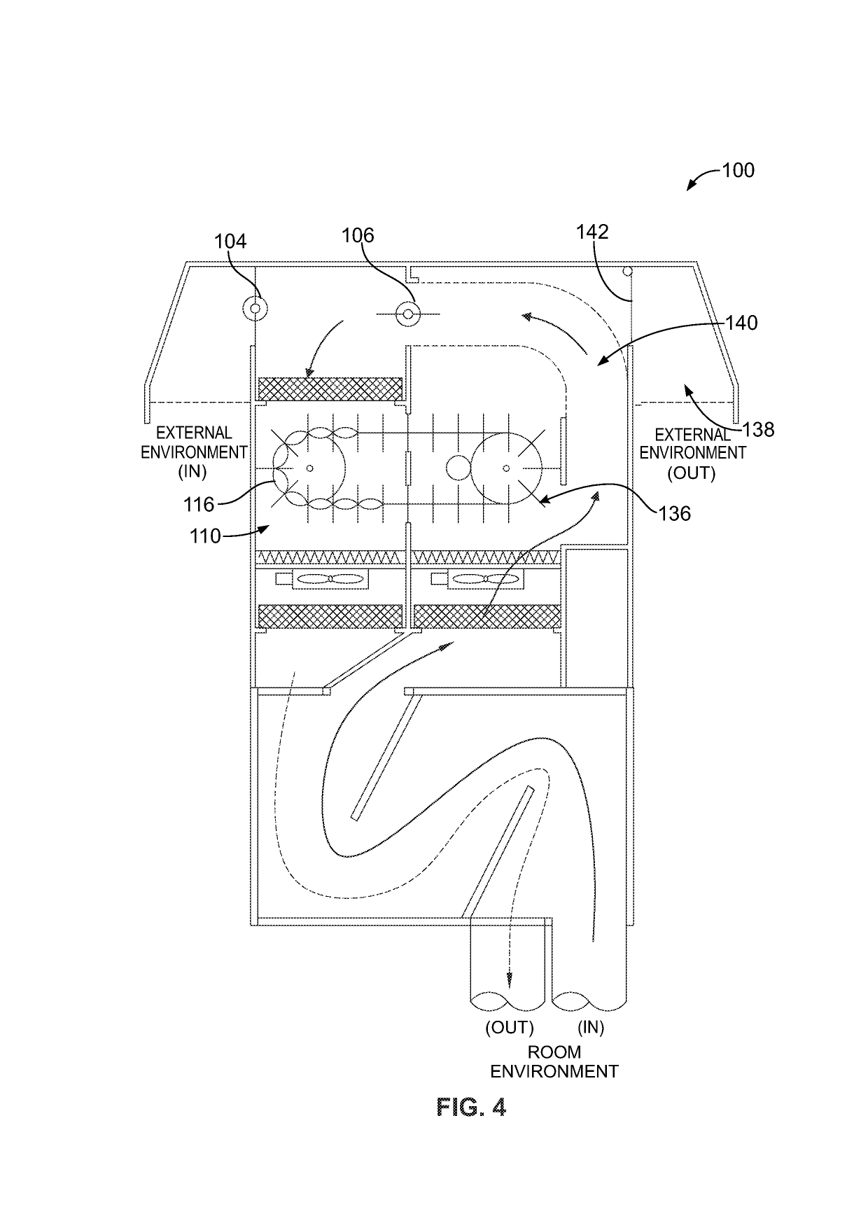

Referring to FIG. 1, an energy recovery ventilator (“ERV”) system 100 includes an air inlet 102 through which, typically, fresh air enters the ERV system 100. The ERV system 100 is useful in stabilizing humidity year-round, including during the winter and the summer, and has a theoretical efficiency near 100%. As explained in more detail in reference to FIGS. 3 and 4, the ERV system can be operated at least in an ERV mode and a dehumidifier mode. A first motor control damper 104 (e.g., a fresh air damper) is positioned generally proximate to the fresh air inlet 102. The fresh air passes through a first filter 108 into a dehumidifying chamber 110 in which a desiccant belt 112 is located, in part. The desiccant belt 112 includes a plurality of separators 114, between which desiccant units 116 (e.g., silica gel packets) are located.

In the dehumidifying chamber 110, the fresh air is modified to achieve a desired humidity. The modified fresh air exits the dehumidifying chamber 110 at relative humidity through a first heat source 118, past a first fan 120 (which drives the flow of air) and a second filter 122, into a counterflow heat exchanger 124 to achieve a desired temperature. From the heat exchanger 124, the modified fresh air exits via an outlet duct 126, typically, into a room that is being cooled.

On an exhaust path, room air enters an inlet duct 128 of the heat exchanger 124 and passes through a third filter 130, a second fan 132 (which drives the flow of air), and a second heat source 134, into a regeneration chamber 136. The room air, as explained in more detail below, is useful for regenerating the desiccant units 116 on the desiccant belt 112, which is movable between the dehumidifying chamber 110 and the regeneration chamber 136.

A motor 137 is operated to move the desiccant belt 112 between the two chambers 110, 136. If the ERV system 100 is not in a dehumidifier mode (which is described in more detail below in reference to FIG. 3), the room air exits the ERV system 100 via an air outlet 138. The second motor control damper 106 (which functions as a bypass damper) is operable to divert the air flow between the desiccant belt 112, in the dehumidifying chamber 110, and a bypass duct 140. An anti-back flow flap 142 is operated between an open position (as illustrated) and a closed position (illustrated in FIG. 4) to control air flow towards the air outlet 138.

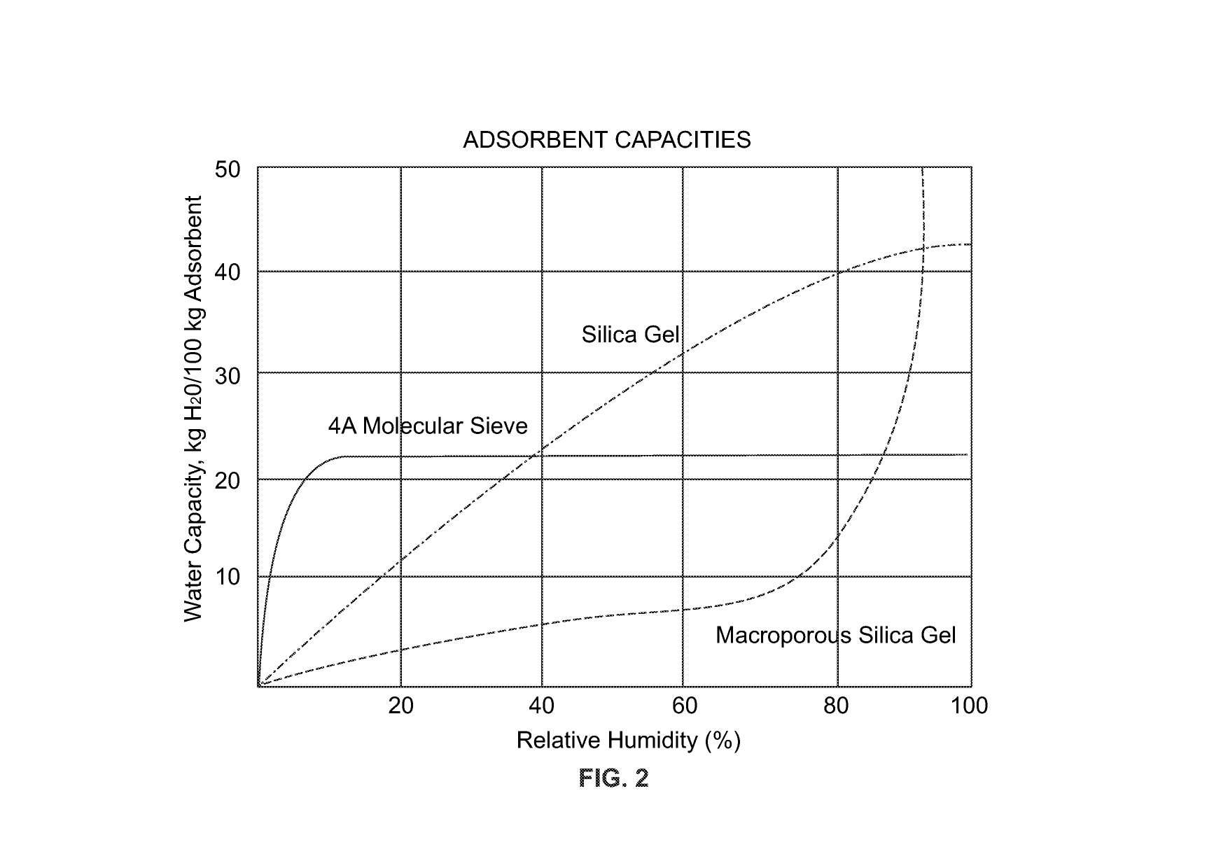

Referring to FIG. 2, a chart illustrates adsorbent properties of various desiccants in relation to a Silica Gel material, which, in contrast to other materials, has a generally linear capacity versus relative humidity in the range of 20-80%. For example, the Silica Gel can adsorb 10 kilograms of water (per 100 kilograms of Silica Gel) at about 20% relative humidity, and about 30 kilograms of water (per 100 kilograms of Silica Gel) at about 60% relative humidity. Thus, the adsorbent capacity of Silica Gel increases, generally linearly, with the relative humidity at a rate of about 1 kilogram of water for about 2% increase in relative humidity.

For the ERV system 100 of the present application, a material exhibiting properties similar to the Silica Gel is preferred because such a material provides good adsorbent capacity, adsorbing sufficient water from the passing air, and because such a material can properly achieve a desired relative humidity based on the linear adsorbent capacity relative to the relative humidity.

Referring to FIG. 3, the ERV system 100 is illustrated in the ERV mode in which fresh air is regulated to a desired humidity, via the dehumidifying chamber 110, and a desired temperature, via the heat exchanger 124. Then, the regulated air is exhausted to a room environment through the outlet duct 126. When passing through the dehumidifying chamber 110, the air passes through the desiccant units 116 so that undesired air moisture is absorbed before the air exits to the heat exchanger 124. The first control damper 104 is in an open position, to allow exterior air to come in the ERV system 100, and the second control damper 106 is in a closed position to divert the air into the dehumidifying chamber 110. The first fan 120 is operated to pull the air through the dehumidifying chamber 110, into the heat exchanger 124.

On the return path, air from the room environment enters the inlet duct 128 and is pulled by the second fan 132 through the heat exchanger 124 into the regeneration chamber 136. The second control damper 106 is in the closed position to ensure that the air passes through the regeneration chamber 136, and does not flow through the bypass duct 140. From the regeneration chamber 136, the air exits through the air outlet 138 to the exterior environment.

In the regeneration chamber 136, the desiccant belt 112 includes desiccant units 116 that require regeneration. After adsorbing moisture from the air in the dehumidifying chamber 110, the desiccant units 116 reach a state in which they become saturated at a higher humidity level and, as such, the desiccant units 116 are no longer removing the desired humidity from the air. When this state is reached, the desiccant belt 112 is rotated to move the desiccant units 116 from the dehumidifying chamber 110 to the regeneration chamber 136. In the regeneration chamber 136, heated and dry air that is expelled from the room environment is utilized to regenerate (or dry) the desiccant units 116. In other words, the relative humidity of the desiccant units 116 is reduced in the regeneration chamber 136. Moisture from the desiccant units 116 (which are now in the regeneration chamber 136) is removed by the passing heated and dry air, which would otherwise be expelled directly towards the air outlet 138 (to the outside, external, environment).

The desiccant belt 112 is rotated to maintain the desiccant units 116 in a saturated equilibrium state to maintain a specific relative humidity. The desiccant belt 112 includes a sufficient volume of desiccant units 116 to achieve the desired relative humidity. According to one embodiment, the volume of desiccant units 116 is high enough to prevent continuous movement of the desiccant belt 112. In other words, the volume of desiccant units 116 is high enough to permit a stationary time period of the desiccant 112, before rejuvenation of the desiccant units 116 is necessary.

Referring to FIG. 4, the ERV system 100 is illustrated in the dehumidifier mode, in which air from the room environment is dehumidified in the dehumidifier chamber 110. In the dehumidifier mode, the first control damper 104 is in the closed position to prevent fresh air from entering the ERV system 100, and the anti-back flow flap 142 is also in the closed position to prevent air expelled from the room environment to exit the ERV system 100 via the air outlet 138. The second control damper 106 is in the open position to allow the air expelled from the room environment to bypass the regeneration chamber 136 via the bypass duct 140. From the bypass duct 140, the air is recirculated to the dehumidifier chamber 110 by moving the second control damper 106 in the open position. In the dehumidifier chamber 110, air from the room environment is regulated to the desired humidity and, then, to the desired temperature in the heat exchanger 124, after which it is passed back toward the room environment.

The second heat source 134 can be a thermal mass that is used to capture the heat of condensation transferred to the incoming air stream in the heat exchanger 124. After a sufficient amount of heat is captured by the thermal mass, the ERV system 100 switches temporarily to the ERV mode to regenerate the desiccant units 116. In another embodiment, the heat source 134 can be a condenser coil located in the high pressure/hot area of an associated air conditioner unit for using waste heat from the air conditioner unit to regenerate the desiccant when the ERV system 100 is in the dehumidifier mode. Thus, the dehumidifier mode recirculates air to/from the room environment such that the only actions are to regulate the air temperature and humidity in the dehumidifying chamber 110. In comparison, the ERV mode circulates air to/from the external environment such that the air temperature and humidity is regulated in the dehumidifying chamber 110 and desiccant units 116 are regenerated in the regeneration chamber 136.

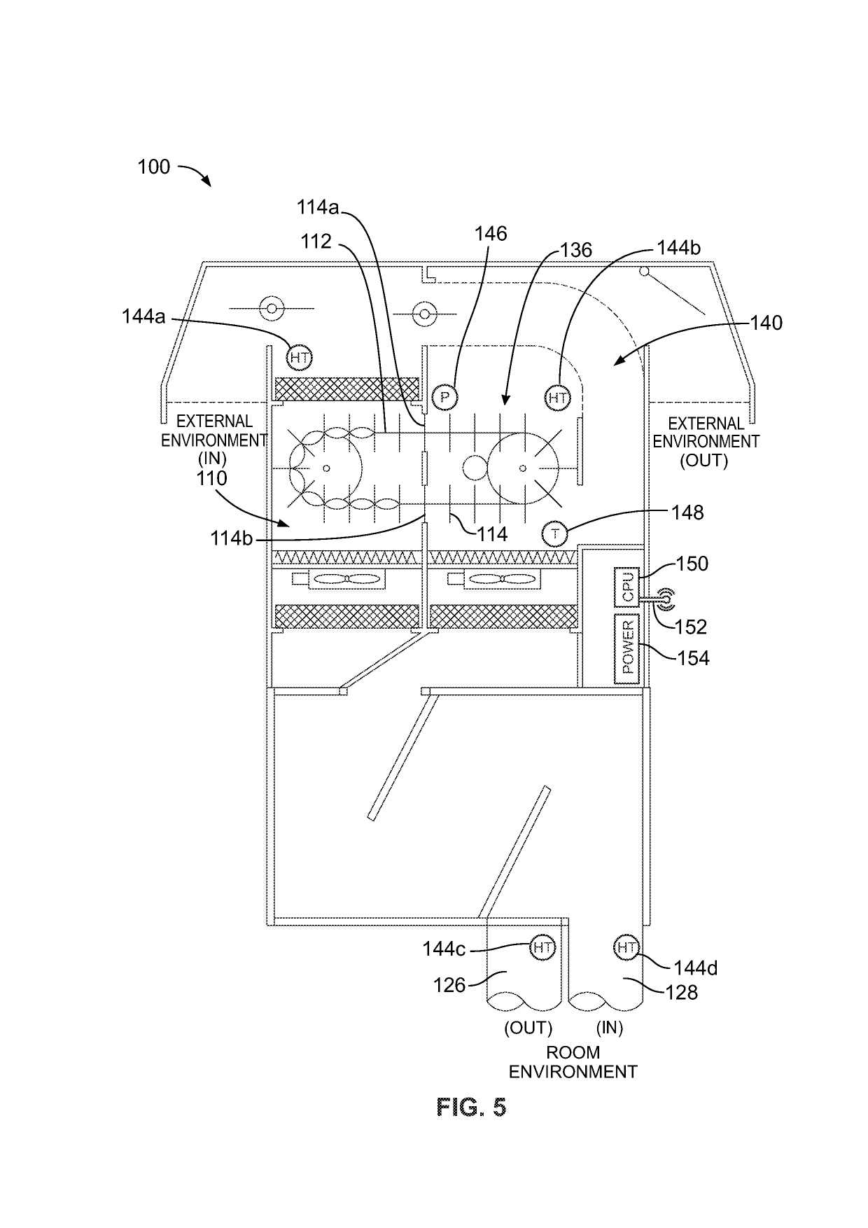

Referring to FIG. 5, the ERV system 100 is illustrated with a plurality of sensors, including humidity and temperature (HT) sensors 144a-144d, a position (P) sensor 146, and a temperature (T) sensor 148. The humidity and temperature sensors 144a-144d include a first sensor 144a near the dehumidifier chamber 110, a second sensor 144b in the regeneration chamber 136, a third sensor 144c in the outlet duct 126, and a fourth sensor 144d in the inlet duct 128.

The sensors are communicatively coupled to a central processing unit (“CPU”) 150, which has an optional antenna 152 for receiving/sending communications. This communication channel can be used, for example, for reporting operational parameters, maintenance status, and operating system upgrades. A power supply 154 provides the required electrical power to operate the ERV system 100. The CPU 150 causes the desiccant belt 112 to move intermittently when a determination is made that the air in the ERV system 100 has degraded to an undesired temperature and/or humidity. The humidity and temperature (HT) sensors 144a-144d provide input to the CPU 150 to determine the amount of energy that has to be recovered. Accordingly, when the energy being recovered is lower than a predetermined energy value, the desiccant belt 112 is moved.

The position sensor 146 senses the position of the desiccant belt 112 to identify movement of the separators 114, as they move between the dehumidifier chamber 110 and the regeneration chamber 136. Two separators of the separators 114, such as a first separator 114a and a second separator 114b, are always positioned in an area between the dehumidifier chamber 110 and the regeneration chamber 136 to seal the two chambers from each other and, consequently, to prevent cross-contamination between air flowing through respective chambers.

In reference to FIGS. 1-5, the ERV system 100 has been described as both an ERV system and a dehumidifier typically as used during the warm and humid months of the year (e.g., summer season). However, the ERV system 100 can also be used during the cold and dry months of the year (e.g., winter seasons), but in reverse. For example, reversing the process, moist desiccant units 116 that require regeneration are now in the dehumidifying chamber 110 and dry regenerated desiccant units 116 are now in the regeneration chamber 136. As such, cold dry air from the external environment passes through the moist desiccant units 116 positioned in the dehumidifying chamber 110, and is humidified in the process. In the return path, hot humid air from the room environment passes through the dry desiccant units 116 in the regeneration chamber 136, filling the dry desiccant units 116 with moisture to be used (after the desiccant belt 112 is rotated) in the humidifying chamber 136.

Referring to FIG. 6, a counterflow heat exchanger 600 has a plurality of layers 602 through which air flows between an external environment and a room environment. Fresh air is directed to the heat exchanger 600 through a first inlet portion 604, from the external environment, and exits through a first outlet portion 606, to the room environment. Room air is directed to the heat exchanger 600 through a second inlet portion 608 from the room environment, and exits through a second outlet portion 610.

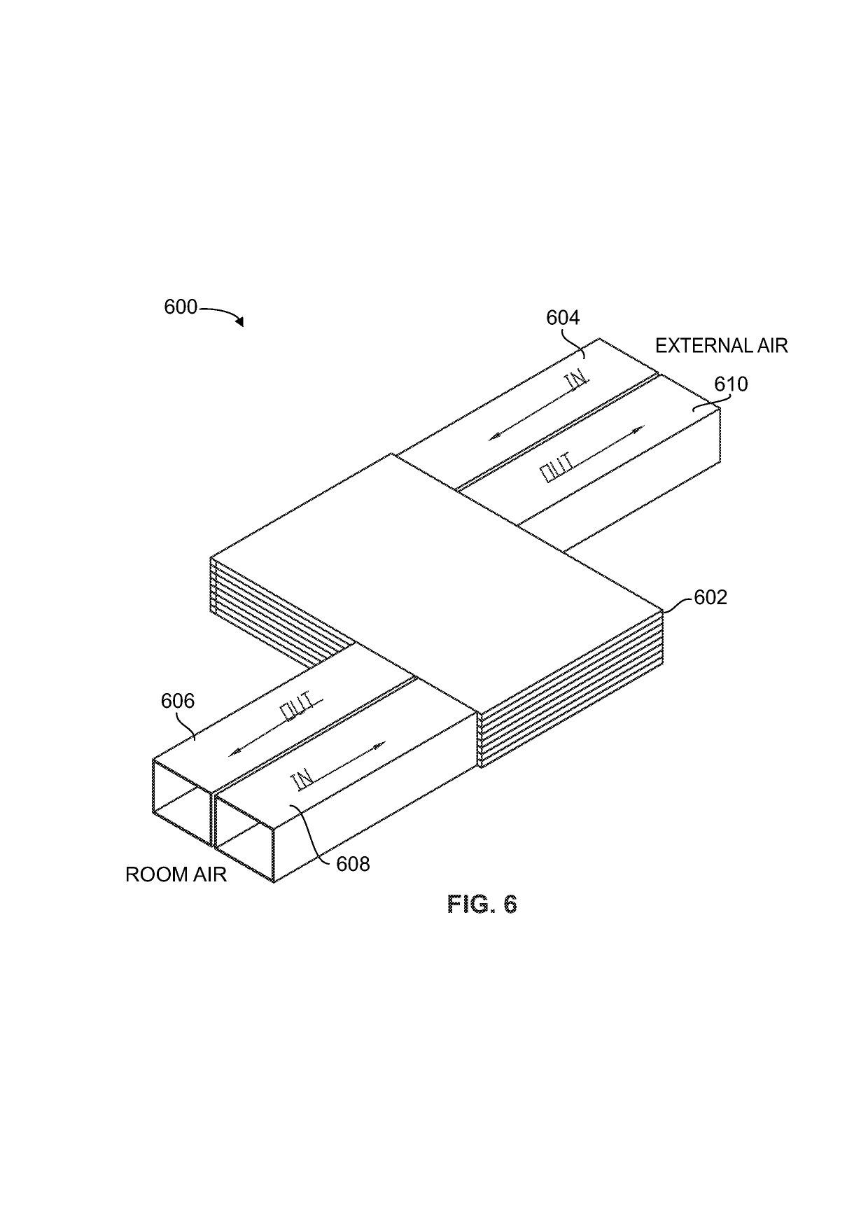

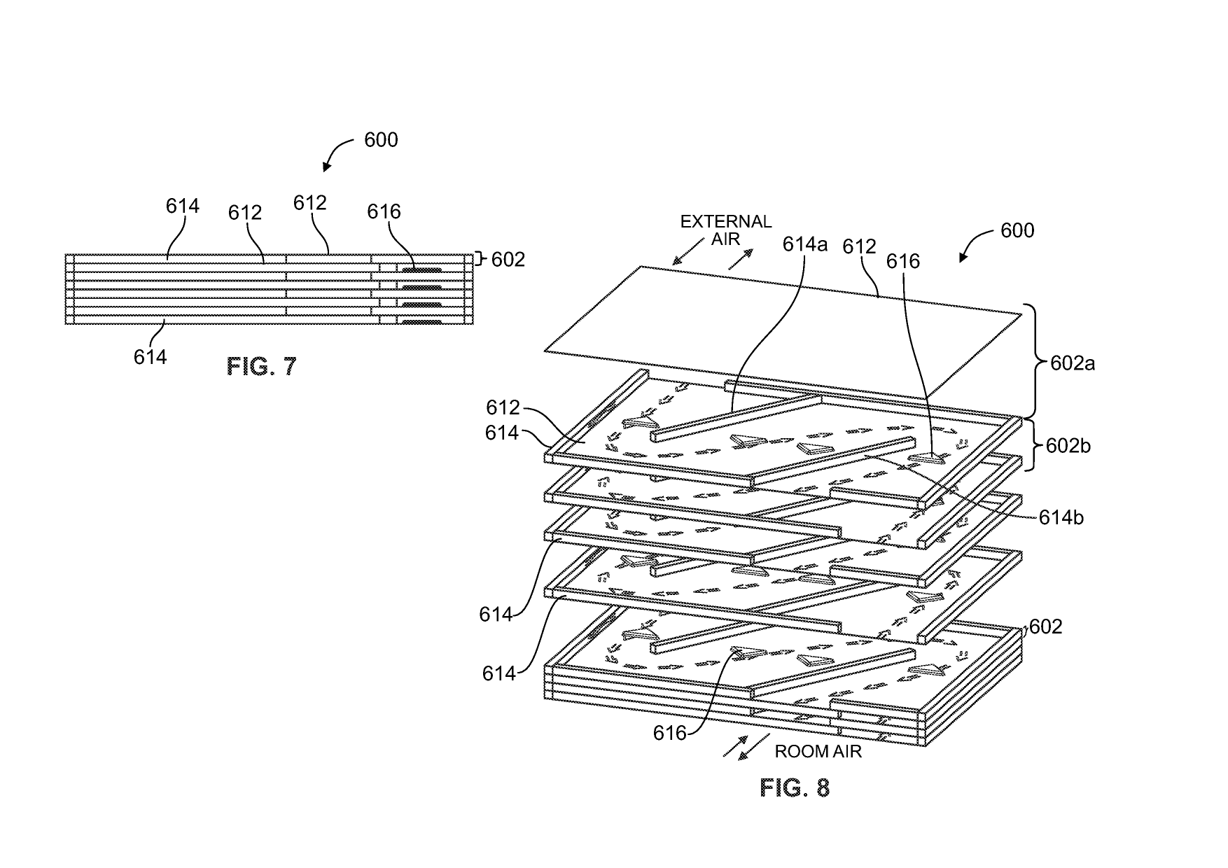

Referring to FIG. 7, the heat exchanger 600 further includes a plurality of plates 612 separated by a plurality of separator segments 614 (also referred to as tape segments). The plates 612 can be made from any desirable material, such as foam tape (e.g., open foam tape) or molded tape, and can have a relatively small thickness, such as a 10 thousandths of an inch thickness. The separator segments 614 are, in general, attached around the periphery of the plates 612 or in an internal area between the plates 612. The heat exchanger 600 further includes a plurality of deformations 616 that are formed on the surface of the plates 612.

Referring to FIG. 8, some separator segments 614a, 614b are oriented across respective ones of the plates 612 to direct air flow in a particular pattern. The deformations 616 are positioned on each layer 602 in a desired pattern to create a respective air flow within the heat exchanger 600. The orientation of the deformations 616 is dependent on the direction of the air flow. For example, the orientation of deformations 616 on a first layer 602a, through which air may flow from the external environment to the room environment, can be directly opposite to the orientation of the deformations 616 on a second layer 602b, through which air may flow from the room environment to the external environment.

The deformations 616 are positioned such that turbulent air flow is achieved in the heat exchanger 600. The deformations 616 can include protruding deformations and/or embossing deformations. Protruding deformations are deformations raised above a thickness plane of the plate 602 (as illustrated in FIG. 8), and embossing deformations are deformations punched below the thickness plane of the pate 602 (not shown). Although the deformations 616 are shown to have a triangular shape, the deformations 616 can have other shapes.

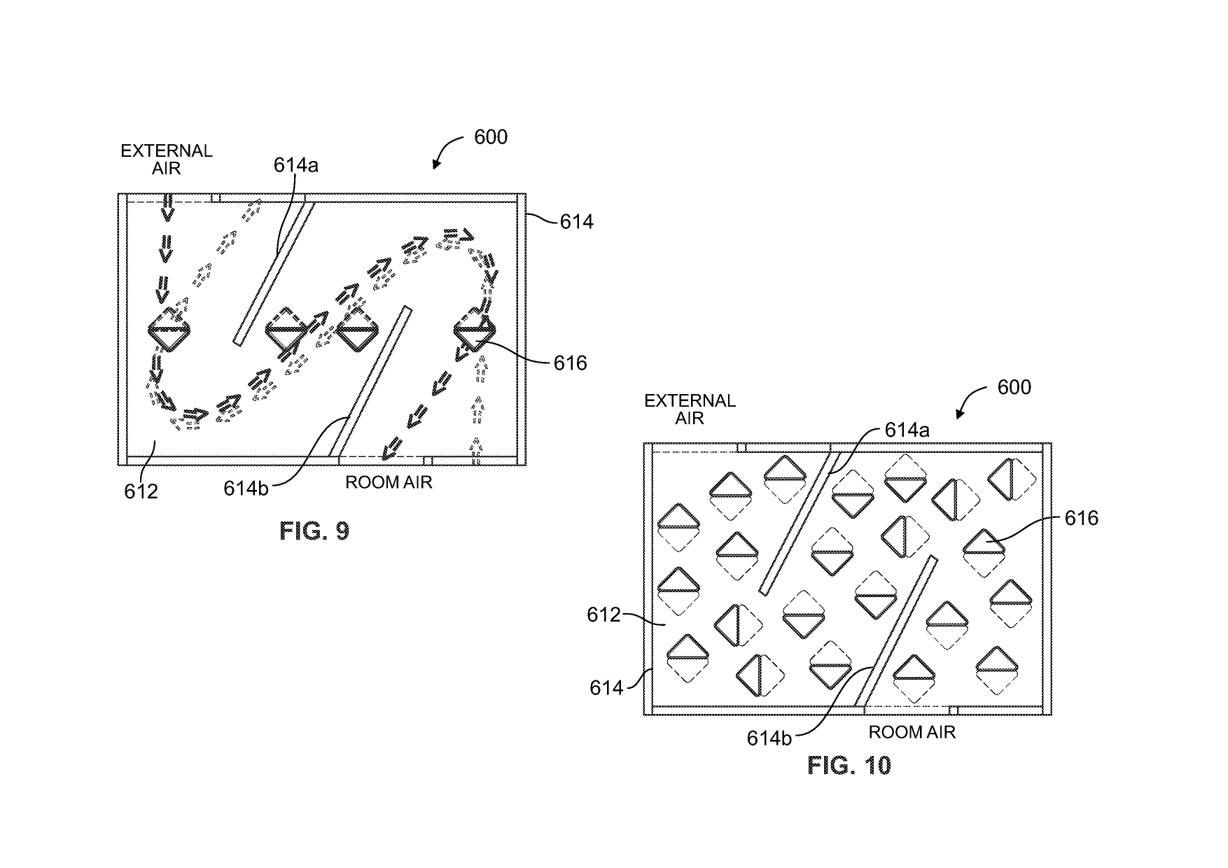

Referring to FIGS. 9 and 10, the deformations 616 can be positioned and oriented in various ways. For example, as illustrated in FIG. 9, only a small number of deformations 616 can be positioned on the plate 612, each of the deformations 616 being oriented in the same direction on the plate 612. In another example, illustrated in FIG. 10, a large number of deformations 616 can be positioned on the plate 612, each of the deformations 616 having a different orientation than at least some of the other deformations 616.

The heat exchanger 600 may be considered to be a disposable heat exchanger because it consists primarily of elements (e.g., plates 612 and separator segments 614) that are relatively inexpensive and easy to manufacture. For example, the cost of one embodiment of the disclosed heat exchanger 600 may be about $50, in contrast to some present heat exchanger that may cost thousands of dollars. Another advantageous aspect of having the separator segments 114 is that they act as a muffler to reduce noise entering the building.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

1. An energy recovery ventilator system comprising:
a first chamber and a second chamber;
a moving belt having a first portion positioned in the first chamber and a second portion positioned in the second chamber;
a plurality of desiccant units positioned on the moving belt, the desiccant units including a plurality of first desiccant units and a plurality of second desiccant units, each of the desiccant units being in a saturated stated,
the first desiccant units being located in the first chamber at a first relative humidity and causing air received in the first chamber to achieve a first air humidity, and
the second desiccant units being located in the second chamber at a second relative humidity, the second relative humidity being caused by the air received in the first chamber, the second desiccant units being modified back to the first relative humidity by air passing through the second chamber, the air passing through the second chamber achieving a second air humidity; and
a controller communicatively coupled to the moving belt and operable to cause movement of the moving belt, the controller causing the moving belt to move at least some of the second desiccant units from the second chamber to the first chamber when the first air humidity fails to comply with a predetermined air humidity.

2. The energy recovery ventilator system of claim 1, wherein a gap is formed along an adjacent boundary between the first chamber and the second chamber, the moving belt including a plurality of separators positioned at predetermined intervals on the moving belt, at least one of the separators being positioned in the gap to seal the first chamber from the second chamber and prevent cross-contamination between air in the first chamber and air in the second chamber.

3. The energy recovery ventilator system of claim 1, wherein the plurality of desiccant units are packets of silica gel.

4. The energy recovery ventilator system of claim 1, wherein the first chamber operates in a dehumidifier mode in which moisture is removed from the air in the first chamber by passing through the first desiccant units, the second chamber operating in an energy recovery mode in which moisture is added to the air passing through the second chamber by passing through the second desiccant units.

5. The energy recovery ventilator system of claim 1, wherein the first chamber operates in a dehumidifier mode during a first time period and in a reverse mode during a second time period.

6. The energy recovery ventilator system of claim 1, wherein, in an energy recovery mode, the air passing through the second chamber is expelled to the external environment.

7. The energy ventilator system of claim 1, further comprising a plurality of sensors, including humidity and temperature sensors, a position sensor, and a temperature sensor,
a first one of the humidity and temperature sensors being positioned near the first chamber;
a second one of the humidity and temperature sensors being positioned near the second chamber;
a third one of the humidity and temperature sensors being positioned near an outlet duct of a heat exchanger that is located adjacent to the first chamber and the second chamber; and
a fourth one of the humidity and temperature sensors being positioned near an inlet duct of the heat exchanger;
wherein the position sensor is located in the second chamber near the moving belt and the temperature sensor is located in the second chamber.

8. The energy ventilator system of claim 1, wherein the controller is coupled to a position sensor, the controller determining whether a gap between the first chamber and the second chamber is properly sealed based on positioning input received from a position sensor located near the moving belt.

9. The energy ventilator system of claim 1, further comprising a heat exchanger including a plurality of layers, each of the layers having two plates separated by a plurality of separator segments.

10. The energy ventilator system of claim 9, wherein the plurality of separator segments include one or more foam tape segments or molded tape segments.

11. The energy ventilator system of claim 9, wherein at least one of the plates is an aluminum plate having at least one deformation formed on a plate surface for deflecting flow of air in the heat exchanger to create a turbulent air flow.

12. The energy ventilator system of claim 11, wherein the at least one deformation is selected from a group consisting of a protrusion deformation and an embossment deformation.

13. The energy ventilator system of claim 9, wherein at least one of the plates has an array of deformations formed on a plate surface, the array causing a turbulent air flow in the heat exchanger.

14. A method for recovering energy in a ventilator system, the method comprising:
receiving fresh air from an external environment into a dehumidifier chamber;
adsorbing moisture from the fresh air to a plurality of first desiccant units to lower the humidity of the fresh air, the first desiccant units being in a saturated state at a first relative humidity;
sending dehumidified air into a room environment;
receiving room air from the room environment into an energy recovery chamber;
removing moisture from the room air to a plurality of second desiccant units, the second desiccant units being in a saturated state at a second relative humidity, the removing of the moisture causing the saturated state at the second relative humidity of the second desiccant units to change to the saturated state at the first relative humidity; and
in response to determining that relative humidity of fresh air is higher than a predetermined humidity, replacing at least one of the first desiccant units from the dehumidifier chamber with a corresponding one of the second desiccant units from the energy recovery chamber.

15. The method of claim 14, further comprising expelling the room air to the external environment after passing through the energy recovery chamber.

16. The method of claim 14, further comprising sealing gaps formed between the dehumidifier chamber and the energy recovery chamber with separators formed in a rotating belt.

17. The method of claim 14, further comprising passing the dehumidified air through layers of a heat exchanger, the layers being formed by two adjacent plates separated by tape segments.

18. The method of claim 17, further comprising creating a turbulent air flow by passing the dehumidified air passed an array of deformations formed on a surface of at least one of the plates.
